(19) United States
(12) Patent Application Publication
(10) Pub. No.: US 2025/0190235 A1
(43) Pub. Date: Jun. 12, 2025

(54) MECHANISM ALLOWING A HOST SOFTWARE STACK TO PROVE ITS IDENTITY AND BUILD TRUST TO A GUEST

(71) Applicant: RED HAT, INC., Raleigh, NC (US)

(72) Inventors: Christophe Marie François Dupont de Dinechin, Valbonne (FR); Michael Tsirkin, Yokneam Illit (IL)

(21) Appl. No.: 18/537,411

(22) Filed: Dec. 12, 2023

(51) Int. Cl. G06F 9/455

(52) U.S. Cl. CPC G06F 9/45558; G06F 2009/4557; G06F 2009/45587

(57) ABSTRACT

An example method may include booting, by a host computer system, an operating system (OS) kernel; locking, by a security service running on the host computer system, a plurality of physical pages in a memory of the host computer system, wherein the plurality of physical pages is designated for use by the OS kernel, wherein the plurality of physical pages, upon locking, are unmodifiable by the OS kernel, and wherein the security service is associated with a privilege level higher than a privilege level of the OS kernel; performing, by the security service, a cryptographic measurement on the plurality of the physical pages; and generating, by the host computer system, a measurement report based on the cryptographic measurement.

### TECHNICAL FIELD

The present disclosure generally relates to computer systems, and is more specifically related to implementing a mechanism for confidential computing to allow a host software stack to prove its identify and build trust to a guest.

### BACKGROUND

Confidential computing is a technique for protecting data in use with enhanced security and privacy. Confidential computing can be used in conjunction with encryption to protect data stored in the storage, for example on disk, and data in transit, for example, through a network. Confidential computing protects data in use by performing computations in a hardware-based trusted execution environment (TEE), which generally features encryption of memory and additional protections of CPU state. Data needs to be assessed to be trustworthy before being provided to the TEE.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1A depicts a high-level block diagram of an example computing system that uses a mechanism for confidential computing to allow a host software stack to prove its identity to a virtual machine so as to build trust, in accordance with one or more aspects of the present disclosure;

FIGS. 1B and 1C depict an example difference between the mechanism for confidential computing to allow a host software stack to prove its identity to a virtual machine so as to build trust according to aspects of the present disclosure shown in FIG. 1C and the existing mechanism shown as prior art in FIG. 1B.

FIG. 2 depicts a block diagram of an example computing device with one or more components and modules for implementing a mechanism for confidential computing to allow a host software stack to prove its identity to a virtual machine so as to build trust, in accordance with one or more aspects of the present disclosure;

FIG. 3 depicts a flow diagram of an example computing device that implements a mechanism for confidential computing to allow a host software stack to prove its identity to a virtual machine so as to build trust, in accordance with one or more aspects of the present disclosure;

FIG. 4 depicts a block diagram of an example computing device operating in accordance with the examples of the present disclosure.

### DETAILED DESCRIPTION

Modern computing devices may use confidential computing techniques to assert the trustworthiness of the hardware and software environment in which their workload is running, regardless of the security posture of the underlying infrastructure provider. One of the confidential computing techniques is attestation. Attestation may enable a program to check the capabilities of a computing device and to detect unauthorized changes to programs, hardware devices, other portions of the computing device, or a combination thereof. For example, the unauthorized changes may be the result of malicious, defective, or accidental actions by an attacker, program, or hardware device. A hardware-based attestation allows a hardware (e.g., processor) to generate cryptographic evidence for a workload-running environment such as a confidential virtual machine. Provided that the workload owner trusts that hardware, workload owner can then remotely verify that evidence and decide whether the workload's execution environment is trustworthy or not. Upon deciding the workload's execution environment is trustworthy, the workload owner can then provision the workload's execution environment with a set of secrets (e.g., container image encryption keys), effectively permitting the workload's execution environment to run the workload.

In some implementations, a computing system (“host”) may provide, to a virtual machine, a guest trusted computing base, which can include a set of trusted components including hardware, firmware, and software. The guest trusted computing base can be used to provide a trusted execution environment (TEE), in which one or more virtual machines can run to provide the execution for one or more guest applications. The TEE offers security guarantees to the virtual machines against malicious or hostile programs. To decide whether the relevant part including software, hardware, and configurations (e.g., file indicating the policy of performing attestation) that is running in the TEE is intact and trustworthy to the workload owner, the virtual machine may employ the trusted hardware to generate attestation data that can be matched against known reference values and/or can be used to enforce security properties of the virtual machine.

In some implementations, when a program running on the host initiates a TEE running on the host, the TEE can allow the relevant part running in the TEE to access a cryptographic measurement of selected content of guest memory, including a guest software stack, and integrate that measurement into an attestation process such that the virtual machine can know whether the measured content of guest memory, including the measured guest software stack can be trusted, for example, by comparing a value reflecting the measured content of guest memory and/or the measured guest software stack with a preset reference value. The guest software stack refers to a collection of components that are stored in the guest memory and work together to support the execution of the workloads by the virtual machines. Specifically, the TEE allows to lock the memory pages, of the guest memory, that correspond to the guest software stack such that the locked memory pages are protected and cannot be written, erased, or modified by the host nor the virtual machine. The host can cryptographically measure the locked memory pages of the guest memory (referred to as “guest measurement”) and generate a report of the guest measurement upon receiving a request for such report.

Aspect of the present disclosure includes a system allowing a virtual machine to integrate a measurement of a host software stack into the attestation process such that the virtual machine can know whether the measured host software stack can be trusted. The host software stack refers to a collection of components that are stored in a host memory and work together to support the execution of the virtual machine. These components may include an operating system, architectural layers, protocols, runtime environments, databases and function calls and may be stacked one on top of each other in a hierarchy. In some implementations, the host software stack may include a portion of host kernel and hypervisors running under control of the host kernel. Specifically, a host that includes memory and one or more processors can allow a secure booting of a host kernel. The secure booting of host kernel also enables a confidential computing firmware to provide a set of runtime services. A security service running on the host may lock memory pages, of the host memory, that correspond to the host software stack and the set of runtime services such that the locked memory pages are protected and cannot be written, erased, or modified by the host, including by the host kernel. The security service is provided with a higher privilege level than the host kernel. The security service can cryptographically measure the locked memory pages of the host memory (referred to as “host measurement”).

When a guest application requires an attestation to verify whether the host software stack that are provided to the guest application are intact and trustworthy, the guest application can send, to the security service, a request for a report, where the report can be used by the guest application for attestation. In response, the security service can generate a report of the host measurement described above, and send the report to the guest application. The guest application can then send an attestation request to an attestation server, and in response, the attestation server can send an attestation challenge to the guest application. Responsive to receiving the attestation challenge, the guest application sends attestation response including the host measurement report to the attestation server, where the host measurement report is authenticated as coming from the security service by a cryptographic signature specific to that service, and as being responsive to the attestation challenge by incorporating a value (“nonce”) derived from the attestation challenge. Attestation response may include attestation data that may be based on the configuration of the host and that may represent the capabilities of the hardware platform, trusted execution environment, executable code, or a combination thereof. Attestation data can be obtained by the hardware platform (e.g., processor, memory, firmware, BIOS) and may include integrity data (e.g., cryptographic hash or signature of executable code), identification data (e.g., processor model or instance), cryptographic data (e.g., signature keys, endorsement keys, session keys, encryption or decryption keys, authentication keys), measurement data, report data, configuration data, settings data, other data, or a combination thereof. Upon receiving the attestation response, the attestation server uses the attestation response to verify at least whether the host software stack are intact and trustworthy. The attestation server may include a policy, e.g., a program, that executes a verification function that takes as input the attestation response and provides output that indicates whether the host software stack are verified. Upon verifying that the host software stack are intact and trustworthy, the attestation server may then provide the protected content (e.g., cryptographic bit sequences or other cryptographic keying material for storing, generating, or deriving a set of one or more cryptographic keys) to the guest application. The guest application may execute the executable code to perform one or more operations that use the protected content. As such, the host extends the attestation of the guest software stack to the attestation of the host software stack such that the guest application can ensure that at least the relevant part of the host, i.e., the host software stack, is intact and trustworthy.

Systems and methods described herein include technology that enables a computing device to use an attestation mechanism to verify the host software stack to prove host identify and build trust to a virtual machine. In particular, aspects of the disclosed technology may allow multiple virtual machines using this attestation mechanism without repeating the measurement process. For example, multiple virtual machines can use the same signed report of the host measurement for attestation. Also, the locked memory pages of the host memory cannot be unlocked until the virtual machine(s) that uses the locked memory pages is (are) no longer running, and the host computer system can only allow this attestation mechanism through such measurement of the locked memory pages. Further, although the locked memory pages are required to reside in the memory when implementing the mechanism, the memory pages to be locked and measured can be selected adaptively according to a need of the system. Various aspects of the above referenced methods and systems are described in details herein below by way of examples, rather than by way of limitation.

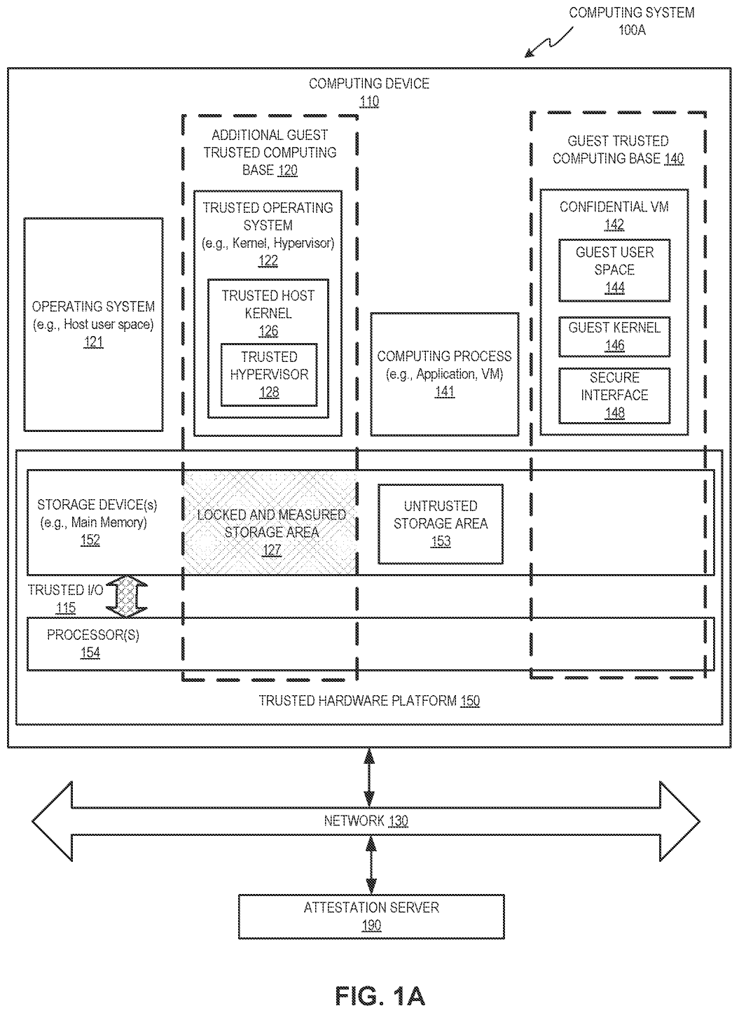

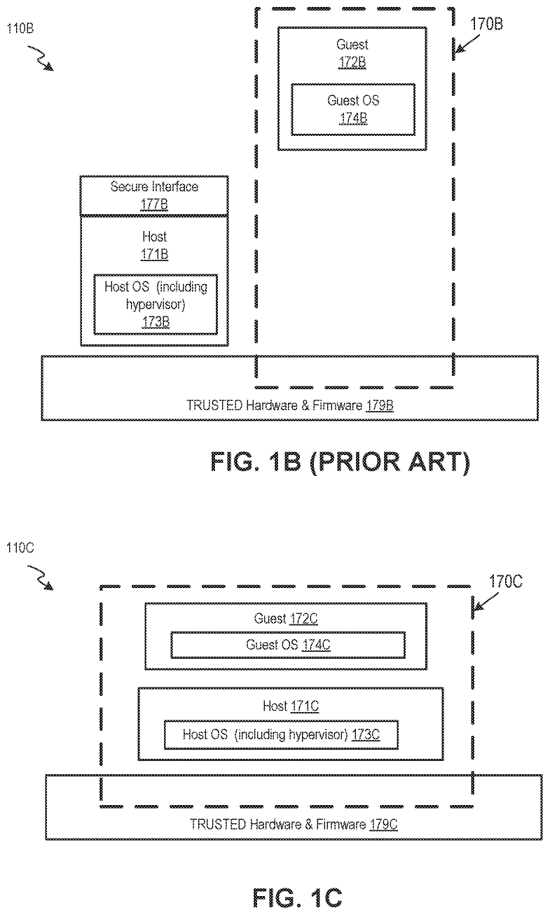

FIG. 1A depicts an illustrative architecture of elements of a computer system 100A, in accordance with an example of the present disclosure. It should be noted that other architectures for computer system 100A are possible, and that the implementation of a computer system utilizing embodiments of the disclosure are not necessarily limited to the specific architecture depicted. The computer system 100A may include a computing device 110, an attestation server 190, and a network 130. In some implementations, the computer system 100A may be in a cloud workload environment.

Computing device 110 may include any computing devices that are capable of storing or accessing data and may include one or more servers, workstations, desktop computers, laptop computers, tablet computers, mobile phones, palm-sized computing devices, personal digital assistants (PDAs), smart watches, robotic devices (e.g., drone), data storage device (e.g., USB drive), other device, or a combination thereof. Computing device 110 may include one or more hardware processors based on x86, Power, SPARC®, ARM®, other hardware, or a combination thereof.

The computing device 110 may provide an execution environment for a virtual machine (“guest,” e.g., a VM 142). Virtual machine may execute guest executable code that uses an underlying emulation of physical resources. Virtual machine may support hardware emulation, full virtualization, para-virtualization, operating system-level virtualization, or a combination thereof. The guest executable code may include a guest operating system, a guest application, guest device drivers, etc. Virtual machine may execute one or more different types of guest operating system, such as Microsoft®, Windows®, Linux®, Solaris®, etc. Guest operating system may manage the computing resources of virtual machine and manage the execution of one or more computing processes. In some implementations, the virtual machine may be connected to hosts (including a server computer system, a desktop computer or any other computing device) in a cloud and the cloud provider system (including one or more machines such as server computers, desktop computers, etc.) via a network.

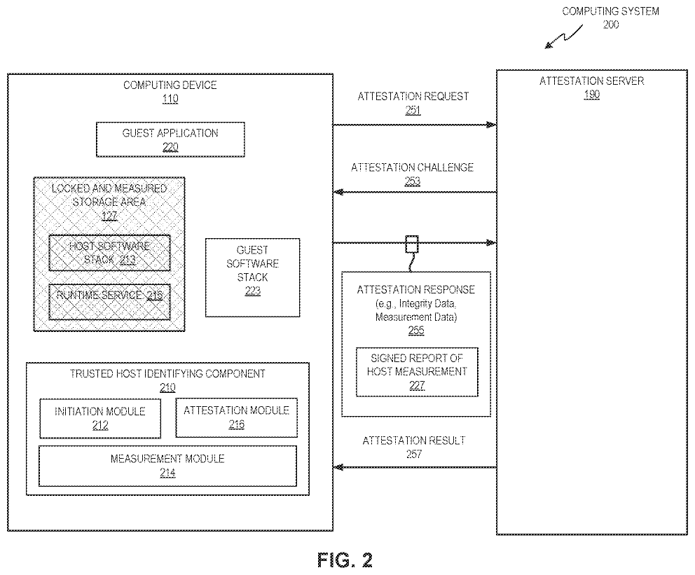

The computing device 110 may perform various attestation operations for the virtual machine to verify that specific component(s) of the computing device 110 are intact and trustworthy, and thus can be trusted by the virtual machine. The computing device 110 may communicate with the attestation server 190 through the network 130 to perform the attestation operations. The network 130 may be a private network (e.g., a local area network (LAN), a wide area network (WAN), intranet, or other similar private networks) or a public network (e.g., the Internet). The detail regarding the attestation is illustrated with respect to FIG. 2.

As shown in FIG. 1A, the computing device 110 may include a trusted hardware platform 150 that forms a base for confidential computing. Based on the trusted hardware platform 150, one or more guest trusted computing base can be established for the virtual machine (e.g., a guest trusted computing base 120, an additional guest trusted computing base 140). Some of the components in the computing device (e.g., an operating system 121, and a computing process 141) can be excluded from the guest trusted computing base such that the virtual machine assumes that these components may be malicious and cannot be trusted. It should be noted that other architectures for computing device 110 are possible, and that the implementations of the computing device utilizing embodiments of the disclosure are not necessarily limited to the specific architecture depicted. In some implementations, the computing device 110 may be referred to as a host computer system.

Trusted hardware platform 150 may include one or more hardware devices that perform computing tasks for computing device 110 and can be trusted by the virtual machine. Trusted hardware platform 150 may include one or more data storage devices, computer processors, Basic Input Output services (BIOS), code (e.g., firmware), other aspects, or a combination thereof. One or more devices of the trusted hardware platform 150 may be combined or consolidated into one or more physical devices or may partially or completely emulated as a virtual device or virtual machine. In the example in FIG. 1A, trusted hardware platform 150 may include one or more storage devices 152 and one or more processors 154.

Storage devices 152 may include any data storage device that is capable of storing data and may include physical memory devices. The physical memory devices may include volatile memory devices (e.g., RAM, DRAM, SRAM), non-volatile memory devices (e.g., NVRAM), other types of memory devices, or a combination thereof. Storage devices 152 may also or alternatively include mass storage devices, such as hard drives (e.g., Hard Disk Drives (HDD)), solid-state storage (e.g., Solid State Drives (SSD)), other persistent data storage, or a combination thereof. Storage devices 152 may be capable of storing data associated with one or more of the operating systems and the computing processes. In one example, data stored in the storage device 152 may be received from a device that is internal or external to computing device 110. The data may be encrypted using a cryptographic key that was generated by computing device 110 or by a different computing device. The received data may be decrypted using the same cryptographic key or a derivative of the cryptographic key and the decrypted data may be loaded into a trusted execution environment before, during or after being re-encrypted. In some implementations, the storage device 152 may include a storage area 127 that can be locked and measured, as described in detail below, and an untrusted storage area 153 where its trustworthiness is unknown to the virtual machine.

Processors 154 may be communicably coupled to storage devices 152 through trusted I/O 115 and be capable of executing instructions encoding arithmetic, logical, or I/O operations. Processors 154 may include one or more general processors, Central Processing Units (CPUs), Graphical Processing Units (GPUs), Application Specific Integrated Circuits (ASICs), secure cryptoprocessors, Secure Elements (SE), Hardware Security Module (HSM), other processing unit, or a combination thereof. Processors 154 may be a single core processor, which may be capable of executing one instruction at a time (e.g., single pipeline of instructions) or a multi-core processor, which may simultaneously execute multiple instructions. Processors 154 may interact with storage devices 152 and provide one or more features defined by or offered by trusted systems, trusted computing, trusted computing base (TCB), trusted platform module (TPM), hardware security module (HSM), secure element (SE), other features, or a combination thereof.

Processors 154 may establish a trusted execution environment across multiple hardware devices of trusted hardware platform 150 (e.g., processor and storage devices) and may include instructions (e.g., opcodes) to initiate, configure, and maintain the trusted execution environment. In one example, a trusted execution environment may be implemented using confidential computing technologies provided by Intel® (e.g., Trusted Domain eXtensions® (TDX) or Software Guard eXtensions® (SGX)), AMD® (e.g., Secure Encrypted Virtualization® (SEV), Secure Memory Encryption (SME, SME-ES), ARM® (TrustZone®), IBM (Protected Execution Facility (PEF)), RISC-V Sanctum, other technology, or a combination thereof. In some implementations, a portion of the processor 154 may be associated with an operating system or a computing process and guard data of operating system or computing process from being accessed or modified by the other operating systems or computing processes. A portion of processor 154 may store the data (e.g., CPU cache, processor memory or registers) and a portion of processor 154 may execute the data (e.g., processor core). The processor 154 may store the data in an encrypted form or in a decrypted form when it is present on the processor and the data of the operating system or computing process may be protected from being accessed or modified by other operating system or processes via the design of the processor and encryption may not be required to ensure isolation of the data when the data is within the processor packaging (e.g., chip packaging).

Trusted I/O 115 may enable the data of a computing process to be transmitted between hardware devices in a security enhanced manner. The data may be transmitted over one or more system buses, networks, or other communication channel in an encrypted or partially encrypted form. This may be advantageous because transmitting the data in an encrypted form may limit the ability of the data to be snooped while being transmitted between hardware devices. As shown in FIG. 1A, trusted I/O 215 may enable the data to be transmitted between trusted storage device 152 and trusted processor 154.

The computing device 110 may include an operating system, for example, the (untrusted) operating system 121 and/or trusted operating system 122. An operating system may manage one or more computing processes. An operating system may include a kernel that execute as one or more kernel processes and may manage access to physical or virtual resources provided by hardware devices. A kernel process may be an example of a computing process associated with a higher privilege level (e.g., hypervisor privilege, kernel privilege, kernel mode, kernel space, protection ring 0). In one example, operating system may be a host operating system, guest operating system, or a portion thereof and the computing processes may be different applications that are executing as user space processes. In another example, operating system may run a hypervisor that provides virtualization features and the computing processes may be different virtual machines. In yet another examples, operating system may run a container runtime (e.g., Docker, Container Linux) that provides operating system level virtualization and the computing processes may be different containers. In further examples, operating system may provide a combination thereof (e.g., hardware virtualization and operating system level virtualization).

In some implementations, the computing device 110 can perform a secure boot of the trusted operating system 122. The secure boot may be performed, for example, by the initiation module 212 of FIG. 2, and the detail thereof is illustrated with respect to FIG. 2. When the secure boot is performed, the computing device 110 verifies the digital signature of any executable files before allowing them to run as the trusted operating system 122. The trusted operating system 122 may run a trusted host kernel 126, and the trusted host kernel 126 may run a trusted hypervisor 128; while the (untrusted) operating system 121 may run a host user space.

The host kernel 126 may load all necessary data from a disk. In some implementations, the host kernel 126 may segregate storage devices 152 (e.g., main memory, hard disk) into multiple portions that are associated with different access privileges. At least one of the multiple portions may be associated with enhanced privileges and may be accessed by processes with enhanced privileges (e.g., kernel mode, kernel privilege) and another portion may be associated with diminished privileges and may be accessed by processes with both diminished privileges (e.g., user space mode, user space privilege) and those with enhanced privileges. In one example, one portion of storage devices 152 associated with the enhanced privileges may be designated as kernel space and another portion of storage devices 152 associated with the diminished privileges may be designated as user space. In other examples, there may be more or less than two portions.

In some implementations, the hypervisor 128, which may also be known as a virtual machine monitor (VMM), may provide virtual machines with access to one or more features of the underlying hardware devices. The hypervisor 128 may run directly on the trusted hardware platform 150. The hypervisor 128 may manage system resources, including access to hardware devices. The hypervisor 128 may be implemented as executable code and may emulate and export a bare machine interface to higher-level executable code in the form of virtual processors and guest memory, as well as additional virtualization specific features, including direct access to the security services provided by the host. Higher-level executable code may comprise a standard or real-time operating system (OS), may be a highly stripped down operating environment with limited operating system functionality and may not include traditional OS facilities, etc.

The computing device 110 may run one or more computing processes, for example, the (untrusted) computing process 141 and the confidential virtual machine 142. A computing process may include one or more streams of execution for executing programmed instructions, and a stream of instructions may include a sequence of instructions that can be executed by one or more processors.

The computing process may include one or more applications, containers, virtual machines, or a combination thereof. Applications may be programs executing with user space privileges and may be referred to as application processes, system processes, services, background processes, or user space processes. A user space process (e.g., user mode process, user privilege process) may have lower level privileges that provide the user space process access to a user space portion of data storage without having access to a kernel space portion of data storage. In contrast, a kernel process may have higher privileges that provide the kernel process access to a kernel space portion and to user space portions that are not guarded by a trusted execution environment. In one example, the privilege associated with a user space process may change during execution and a computing process executing in user space (e.g., user mode, user land) may be granted enhanced privileges by an operating system and function in kernel space (e.g., kernel mode, kernel land). This may enable a user space process to perform an operation with enhanced privileges. In another example, the privilege associated with a user space process may remain constant during execution and the user space process may request an operation be performed by another computing process that has enhanced privileges (e.g., operating in kernel space). The privilege levels of a computing process may be the same or similar to protection levels of processor (e.g., processor protection rings) and may indicate an access level of a computing process to hardware resources (e.g., virtual or physical resources). There may be multiple different privilege levels assigned to the computing process. In one example, the privilege levels may correspond generally to either a user space privilege level or a kernel privilege level. The user space privilege level may enable a computing process to access resources assigned to the computing process but may restrict access to resources assigned to another user space or kernel space computing process. The kernel space privilege level may enable a computing process to access resources assigned to other kernel space or user space computing processes. In another example, there may be a plurality of privilege levels, and the privilege levels may include a first level (e.g., ring 0) associated with a kernel, a second and third level (e.g., ring 1-2) associated with device drivers, and a fourth level (e.g., ring 3) that may be associated with user applications. In another example, one or more privilege level exist (such as System Management Mode on x86 processors, or Secure Monitor Mode/Exception Level 3 on ARM®) that are reserved for the firmware, for the hardware platform, or for security services, such that the host operating system kernel has no access or restricted access to these resources.

The confidential virtual machine 142 may be provided as a trusted execution environment that provides code execution, storage confidentiality, and integrity protection, and may store, execute, and isolate data from other processes executing on computing device 110. The computing device 110 may use the same processor and storage device to establish multiple instances of trusted execution environment, and each instance of a trusted execution environment (e.g., TEE instance, TEEi) may be established for a particular set of one or more computing processes and may be associated with a particular memory encrypted area. The instances of a trusted execution environment may be provided by the same hardware (e.g., processor and memory) but each instance may be associated with a different memory encrypted area and a different set of one or more processes (e.g., set including an individual process or set of all processes of a VM). Each instance may guard all data of a computing process or a portion of the data of a computing process. For example, a computing process (e.g., application or VM) may be associated with both a trusted execution environment and an untrusted execution environment. In this situation, a first portion of the data of computing process may be stored and/or executed within trusted execution environment and a second portion of the data of computing process may be stored and/or executed within an untrusted execution environment. The second portion may be stored in the same storage device as the first portion but the second portion may be stored in a decrypted form and may be executed by processor in a manner that enables another process (e.g., multiple higher privileged processes) to access or modify the data.

The confidential virtual machine 142 may provide a security enhanced environment in computing device 110 that may prevent other processes such as the computing process 141 from accessing the data of a computing process. The confidential virtual machine 142 may enhance security by enhancing confidentiality (e.g., reducing unauthorized access), integrity (e.g., reduce unauthorized modifications), availability (e.g., enable authorized access), non-repudiation (e.g., action association), other aspect of digital security or data security, or a combination thereof. The confidential virtual machine 142 may protect data while the data is in use (e.g., processed by processor 154), is in motion (e.g., transmitted over network 130), is at rest (e.g., stored in storage device 152), or a combinational thereof. The confidential virtual machine 142 may be a set of one or more trusted execution environments and each of the trusted execution environments may be referred to as an instance of a trusted execution environment (i.e., TEEi). Each trusted execution environment may isolate data of at least one process executed in trusted execution environment from processes executing external to the trusted execution environment. At least one process may be a set of one or more processes associated with an execution construct being guarded by the confidential virtual machine 142. The execution construct may be a virtual machine, container, computing process, thread, instruction stream, or a combination thereof.

In the example shown in FIG. 1A, confidential virtual machine 142 may be provided as a VM based TEE and may effectively protect data of the virtual machine from accesses by hypervisor managing the virtual machine. In some implementations, such protection is provided by encrypting the data, storing the data in the encrypted form, and allowing decryption of the data only in the confidential virtual machine 142. In this example, computing device 110 may execute executable code (e.g., data in the decrypted form) in confidential virtual machine 142 as a virtual machine process, but cannot access the data in the hypervisor. Thus, the executable code in the confidential virtual machine 142 may be accessible to the virtual machine process and inaccessible to a hypervisor managing the virtual machine process. For example, all the data in the confidential virtual machine 142 may be inaccessible to a hypervisor (e.g., hypervisor 128) managing the confidential virtual machine 142. The confidential virtual machine 142 may include guest user space 144 and a guest kernel 146, and may also include a secure interface 148 for safe communication with other internal or external components of the computing device 110.

In another example, the confidential virtual machine 142 may be replaced with a trusted expectation environment associated with a particular computing process (e.g., process based TEE) and may guard data of the particular computing process from being access by other equally privileged, higher privileged, or lower privileged computing processes (e.g., guard application process against higher privileged Operating System (OS) process). In this example, computing device 110 may execute the executable code in trusted execution environment as one or more application processes and the executable code in the trusted execution environment may be accessible to the one or more application processes and inaccessible to a kernel managing the one or more application processes. As such, trusted execution environment of computing device 110 may host one or more application processes that execute the executable data and the data in the trusted execution environment may be accessible to the one or more application processes and be inaccessible to a kernel managing the one or more application processes.

In some implementations, the computing device 110 may include a guest trusted computing base 140 that provides a trusted execution environment (TEE) (e.g., confidential virtual machine 142), in which a virtual machine can run to provide the security-enhanced execution environment to the virtual machine (e.g., an application in the guest user space 144). The guest trusted computing base 140 may include the confidential virtual machine 142, related area of storage device 152, and related area of processor 154. For example, the trusted area in the storage device 152 in the confidential virtual machine 142 may include a guest software stack (not shown), which can be verified though an attestation process.

For determining whether a guest software stack is trustable to the virtual machine, the virtual machine may implement a mechanism to have the trusted hardware lock a corresponding portion of the guest memory so that the locked portion of the guest memory is unmodifiable (e.g., write protected, erase protected). The trusted hardware may then cryptographically measure the locked portion of the guest memory, and generate and sign a report including the guest measurement. The virtual machine may present the report as an attestation response to an attestation server, and the attestation server can verify whether the software is trustable using the attestation response. Therefore, such attestation provides verification of the guest software stack.

The computing device 110 may include an additional guest trusted computing base 120, which includes the trusted operating system 122, and a storage area 127. The storage area 127 can be locked and measured (e.g., by measurement module 214) and verified (e.g., by attestation module 216), and thus can include a trusted host software stack 213.

The locked and measured storage area 127 may span over one or more storage devices 152 that store data of the trusted operating system 122. Data in the locked and measured storage area 127 may be protected from modifying by the trusted operating system 122 or other operating systems (e.g., operating system 121) running on the computing system 110. For example, data in the locked and measured storage area 127 may be protected from writing, erasing, or modifying by the host kernel 126 and the hypervisor 128. In some implementations, a security service running on the computing device 110 is associated with a privilege level higher than the privilege level of the host kernel 126 and the hypervisor 128, and the security service can lock the memory pages in the storage area 127 and maintain a page table that includes mapping of the locked memory pages. As such, the host kernel 126 and the hypervisor 128 cannot access the page table and thus cannot access the locked and measured storage area 127. In some implementations, the computing device 110 may use one or more sets of page tables to translate virtual addresses to physical addresses. For example, a set of page tables may include host page tables stored in the host memory, and the host page tables may translate the guest physical addresses (GPAs) or guest virtual addresses (GVAs) to host physical addresses (HPAs) (e.g., actual memory locations). A page table may include mappings of privileged memory pages that are accessible only to kernel code and mappings of unprivileged memory pages that are accessible to user code. The mappings of privileged memory pages that are accessible only to kernel code may include mappings of unlocked memory pages that are accessible to kernel code as normal and mapping of locked memory pages that are not accessible to kernel code. The computing device 110 may distinguish the mappings of unlocked memory pages and the mapping of locked memory pages by setting a lock flag. For example, the mappings of the locked memory pages may be associated with a lock flag indicating that the locked memory pages are not accessible to the kernel code. In one example, the lock flag makes the locked memory pages as if they have been swapped out.

The storage area 127 may be referred to as a protected storage area and may be a contiguous or non-contiguous portion of virtual memory, logical memory, physical memory, other storage abstraction, or a combination thereof. The storage area 127 may be mapped to a portion of primary memory (e.g., main memory), auxiliary memory (e.g., solid state storage), adapter memory (e.g., memory of graphics card, or network interface cart), other persistent or non-persistent storage, or a combination thereof. In one example, the storage area 127 may be a portion of main memory associated with a particular process and the processor may protect the data when storing the data in the storage area 127. The data in the storage area 127 cannot be transformed (e.g., encrypted or decrypted) after it is protected and may remain unchanged while in the protected memory area.

The storage area 127 may include one or more storage units. The storage units may be logical or physical units of data storage for managing the data (e.g., storing, organizing, or accessing the data). In one example, a storage unit may be a virtual representation of underlying physical storage units, which may be referred to as physical storage blocks. Storage units may have a unit size that is the same or different from a physical block size provided by an underlying hardware resource. The storage unit may include volatile or non-volatile data storage. In one example, storage units may be a memory segment and each memory segment may correspond to an individual memory page, multiple memory pages, or a portion of a memory page. In other examples, each of the storage units may correspond to a portion (e.g., block, sector) of a mass storage device (e.g., hard disk storage, solid state storage). The data in the storage units of the storage area 127 may be transmitted to other hardware devices using trusted I/O 115. The detail of the operations associated with the storage area 127 is illustrated with respect to FIG. 2.

FIGS. 1B and 1C depict an example difference between the mechanism for confidential computing to allow a host software stack to prove its identify and build trust to a virtual machine according to aspects of the present disclosure shown in FIG. 1C and the existing mechanism shown as prior art in FIG. 1B. Referring to FIG. 1B, the computing device 110B may provide a guest trusted computing base 170B based on part of the trusted hardware and firmware 179B such that the guest 172B, including the guest OS 174B is provided with a security execution environment. However, the guest trusted computing base 170B does not include the host 171B. If the guest 172B needs to use some components from the host 171B, such as the host OS 173B, an extra process for ensuring the security of the host 171B is required. For example, a secure interface 117B may be provided to enable the guest 172B to safely use some components from the host 171B. Therefore, existing mechanism does not include a host software stack of the host 171B in the guest trusted computing base 170B.

By contrast, referring to FIG. 1C, the computing device 110B may provide a guest trusted computing base 170C based on part of the trusted hardware and firmware 179C, and the guest trusted computing base 170C includes the guest 172C and the host 171C such that the guest 172C is provided with a security execution environment including a host software stack of the host 171C. The guest 172C can safely use some components from the host 171C including the host OS 173C. As such, the mechanism according to the aspects of the present disclosure expands the existing machoism by including a host software stack of the host 171C in the guest trusted computing base 170C.

FIG. 2 depicts a block diagram illustrating an example computing system 200 that implements a mechanism for confidential computing to allow a host software stack to prove its identify and build trust to a virtual machine. The computing system 200 may include a computing device 110 and an attesting server 190 that are same to FIG. 1A. In some implementations, the computing device 110 may include a trusted host identifying component 210. The components and modules discussed herein may be performed by any portion of a computing device. For example, one or more of the components or modules discussed below may be performed by processor circuitry, processor firmware, a driver, a kernel, an operating system, an application, other program, or a combination thereof. More or less components or modules may be included without loss of generality. For example, two or more of the components may be combined into a single component, or features of a component may be divided into two or more components. In one implementation, one or more of the components may reside on different computing devices. Trusted host identifying component 210 may include an initiation module 212, a measurement module 214, and an attestation module 216.

Initiation module 212 may enable computing device 110 to perform a secure boot of a host kernel (e.g., host kernel 126). Secure boot is a firmware security feature that ensures only immutable and signed software are loaded during the boot time and works by using a digital signature provided by the certificate authority to verify the authenticity of the system's software and the operating system's files. The digital signature ensures the operating system has not been tampered with and is from a trusted source. When secure boot is enabled, the computing device 110 will verify the digital signature of any executable files before allowing them to run. After verifying, the host kernel loads all the necessary pages from the memory device (e.g., a kernel module such as kvm-intel.ko from disk, in order to provide kernel virtual machine (KVM) support to hypervisors such as gemu on the Linux® operating system).

Initiation module 212 may enable computing device 110 to call a firmware included in the trusted hardware platform 150 to request incorporating a set of memory pages corresponding to runtime services 215 in the storage area 127. The firmware (not shown) may, in response, incorporate the memory pages of the runtime service 215 in the storage area 127. Initiation module 212 may also incorporate a set of memory pages (e.g., physical pages) corresponding to a host software stack 213 to the locked and measured storage area 127. In the example of FIGS. 1-2, the trusted host software stack 213 corresponds to the memory pages reserved for the host kernel 126 and the hypervisor 128.

The measurement module 214 may enable computing device 110 to lock and measure the storage area 127. Locking the storage area 127 may involve protecting the storage area 127 from being written, erased, or modified. In some implementations, the measurement module 214 is associated with a privilege level (e.g., the highest privilege level) higher than a privilege level of a host kernel. For example, the measurement module 214 may be associated with a privilege level higher than any one of hypervisor privilege, kernel privilege, kernel mode, kernel space, protection ring 0. The measurement module 214 may be an internal part of the computing device 110, or may be external to the computing device 110. The measurement module 214 may maintain a page table including multiple page table entries, where each page table entry corresponds to one or more memory pages in the storage area 127. This page table cannot be modified until the virtual machines that uses this mechanism with the storage area 127 are no longer running. The measurement module 214 may make the storage area 127 inaccessible to processes including, for example, the host kernel 126 and the hypervisor 128. In some implementations, the measurement module 214 may make the host software stack 213 and the runtime service 216 also inaccessible. As such, the measurement module 214 locks the storage area 127 so that the memory pages in the storage area 127 cannot be written, erased, or modified.

Measuring the storage area 127 may involve performing a cryptographic measurement operation (e.g., by platform configuration register (PCR) in a trusted platform module (TPM)) to the storage area 127. Specifically, the measurement module 214 may cryptographically measure the storage area 127 by applying a cryptographic hash function to data (e.g., data of host software stack 213 and the runtime service 216) and the metadata associated with the data, (e.g., host physical address where the data is being placed) stored in the storage area 127 and generate a hash value as a host measurement. The hash value is unique and can be used in the attestation process as a reliable code identifier to be provided to remote or local verifier.

The computing device 110 may create and configure a confidential virtual machine 142. To create the confidential virtual machine 142, the computing device 110 may execute one or more instructions recognized directly by the processor (e.g., Intel SGX or TDX opcodes, AMD SEV opcodes) or by supporting firmware (e.g., code provided by trusted enclaves on Intel platforms, code executing in the platform security processor on AMD platforms). In one example, a program that will execute in the confidential virtual machine 142 may initiate the creation of the confidential virtual machine 142. In another example, a program may initiate the creation of the confidential virtual machine 142 and the confidential virtual machine 142 may be used for executing another program. In either example, after the confidential virtual machine 142 is initiated, the computing device 110 may configure the confidential virtual machine 142 to store or execute data of a computing process (e.g., application or virtual machine). In one example, the computing device 110 may configure the confidential virtual machine 142 using the configuration data provided by a process initiating or using the confidential virtual machine 142, by a processor, storage device, other portion of computing device 110, or a combination thereof. As discussed above, the confidential virtual machine 142 may include a trusted storage area, a trusted processor area, trusted I/O, or a combination thereof and the configuration data may include data for configuring one or more of these. For example, configuration data may include an execution construct data (e.g., processes identifier (PID), virtual machine identifier (VMID)), a storage data (e.g., storage size or location), cryptographic data (e.g., encryption key, decryption key, seed, salt, nonce), other data, or a combination thereof. In one example, the confidential virtual machine 142 may include an encrypted storage area and the configuration data may indicate a size of the encrypted storage area that will be allocated to store the computing processes (e.g., size of virtual memory for a trusted storage area). In some implementations, the computing device 110 may configure different aspects of the confidential virtual machine 142 to use various cryptographic techniques. In one example, data of a computing process that will be executed by the confidential virtual machine 142 may be encrypted using a first cryptographic technique (e.g., encrypted using a location independent transport key) when loaded by the processor and may be encrypted using a second cryptographic technique (e.g., encrypted using a location dependent storage key) when stored in the encrypted storage area. This may be advantageous because the data may be more vulnerable to attack when it is stored on a removable storage device (e.g., memory module) then when it is transferred over the system bus and therefore different cryptographic techniques may be used.

In some implementations, the computing device 110 may make a guest memory of the confidential virtual machine 142 inaccessible to other processes including, for example, the host kernel 126 and the hypervisor 128. For example, a set of page tables may include guest page tables stored in the guest memory, where the guest page tables may translate the guest virtual addresses (GVAs) to guest physical addresses (GPAs). A guest page table may include mappings of unlocked memory pages that are accessible to code as normal and mappings of locked memory pages that are only accessible to code of the confidential virtual machine 142. The computing device 110 may distinguish the mappings of unlocked memory pages and the mapping of locked memory pages by setting a lock flag. For example, the mappings of the locked memory pages may be associated with a lock flag indicating that the locked memory pages are only accessible to the code of the confidential virtual machine 142.

In some implementations, the guest memory of the confidential virtual machine 142 may include the guest software stack 223, and the measurement module 214 may enable computing device 110 to lock and measure the guest software stack 223. The measurement module 214 may lock the guest software stack 223 so that the memory pages in the guest software stack 223 cannot be written, erased, or modified. After locking the memory pages of the guest software stack 223, the computing device 110 may cryptographically measure the contents of these memory pages and measures the metadata associated with these memory pages, e.g., guest physical address where the memory pages are being placed. Similarly, as described above, the measurement module 214 may use a hash function to apply to the locked data (e.g., guest software stack and required data) and generate a hash value as a guest measurement.

As an illustrated example shown in FIG. 2, a guest application 220 may be an application running on the confidential virtual machine 142, and may request an attestation by using attestation response described above. The guest application 220 may transfer attestation response to or from an external device (e.g., attestation server 190) that is accessible over an external connection (e.g., network, internet, ethernet, or cellular connection) using a network adapter. The network adapter may write the attestation response directly to memory of computing device 110 (e.g., Direct Memory Access (DMA)) or may provide the attestation response to the processor and the processor may write the attestation response to memory. The attestation response may be transferred over one or more encrypted communication channels. An encrypted communication channel may be established by the hardware platform (e.g., processor) and may encrypt the data that is transferred over the network using hardware based encryption so that the unencrypted data is accessible to the hardware platform and confidential virtual machine 142 without being accessible to any process executed external to the confidential virtual machine 142. The attestation response may include protected content (e.g., cryptographic key data), executable code (e.g., machine code, instruction calls, opcodes), non-executable data (e.g., configuration data, parameter values, settings files), other data, or a combination thereof.

When the guest application 220 needs to perform an attestation operation to verify the integrity of the host software stack 213, the guest application 220 may generate a public/private key pair K1 and K2 and request to the measurement module 214 for a report. The measurement module 214 computes a hash value H1 of the data stored in the storage area 127. The measurement module 214 may create a report including the public key K1 and the hash value H1 and sign it with the private key K2. As such, the measurement module 214 generates a signed report of the host measurement. When the guest application 220 attempts to verify the integrity of the host software stack 213, the guest application 220 retrieves the signed report from the measurement module 214 and sends, through an attestation module 216, attestation response including the signed report of the host measurement to a verifier (e.g., attestation server 190). In some implementations, similarly, as described above, the measurement module 214 may generate the signed report of the guest measurement to perform an attestation operation to verify the integrity of the guest software stack 223.

The attestation module 216 can perform one or more attestation operations by first determining the attestation response and then transmitting the attestation response to the programs executing on the local or remote computing devices for verification. In one example, determining the attestation response may involve attestation chaining in which attestation data of different portions of computing device may be combined before, during, or after being obtained. This may involve determining attestation data for one or more layers of the computing device 110 and the layers may correspond to hardware device layer (e.g., hardware platform attestation data), program layer (e.g., code attestation data), other layer, or a combination thereof.

The attestation may involve performing local attestation, remote attestation, or a combination thereof. Local attestation may involve enabling a program executed locally on computing device 110 to verify the integrity of computing device 110. Remote attestation may involve enabling a program executed remotely on a different computing device (e.g., attestation server 190) to verify the integrity of computing device 110. The remote attestation may be performed non-anonymously by disclosing data that uniquely identifies computing device 110 or anonymously without uniquely identifying computing device 110 (e.g., Direct Anonymous Attestation (DAA)). In the example of FIGS. 1 and 2, the remote attestation provided by an attention server 190 is illustrated.

Specifically, the guest application 220 provided by the confidential virtual machine 142 may use the attestation module 216 to perform an attestation for host verification. The attestation module 216 may send (e.g., through a secure interface 148) an attestation request 251 to an attestation server 190. The attestation server 190 may, in response, send an attestation challenge 253 to the attestation module 216. The attestation module 214 may send, to the attestation server 190, attestation response 255 including the signed report of the host measurement 227. The attestation server 190 may use the attestation response 255 to perform an attestation and send the attestation result 257 to the attestation module 216. As such, the attestation module 216 can identify that the part of the host that corresponds to the memory storage 127 can be trusted. In some implementations, the attestation response 255 may also include the signed report of the guest measurement (not shown), and the attestation module 216 can correspondingly identify that the part of the virtual machine that corresponds to the guest software stack 223 can be trusted.

In some implementations, the attestation module 216 may perform operations before, during, or after the confidential virtual machine 142 is established on computing device 110. The attestation module 216 may provide attestation response that is specific to the initiation, configuration, or execution of the confidential virtual machine 142 that runs the guest application 220. In one example, attestation module 216 may perform a key exchange with the attestation server 190 (e.g., Diffie-Hellman Key Exchange), establish hardware root of trust, and provide the attestation response to the attestation server 190.

In the example of FIGS. 1 and 2, the verifier may be the attestation server 190 including a program that can receive the attestation response and use the attestation response to verify the capabilities of computing device 110. The program may execute a verification function to verify the computing device 110 using the attestation response. The verification function may take as input the attestation response and provide output that indicates whether the computing device 110 is verified (e.g., trusted). In one example, the attestation response may include integrity data (e.g., a message authentication code (MAC)) and the verification function may analyze a portion of attestation response to generate validation data. The verification function may then compare the received integrity data with the generated validation data to perform the attestation (e.g., compare received MAC with generate MAC). In another example, the verification function may take as input data from a different source, such as source code or compiled code and generate validation data that is compared to the received attestation response to determine if the computing device 110 can be trusted to perform a particular set of operations (e.g., combine keys and execute communal operation).

The attestation server 190 may analyze the attestation response to verify the capabilities of the computing device 110. The attestation server 190 may use one or more verification functions that may take as input the attestation response and provide output that indicates whether the remote computing device is verified or unverified. The verification function may generate validation data based on source data (e.g., hash of computer code) and analyze the attestation response in view of the validation data to determine if the executable code in the trusted execution environment of the remote device is valid (e.g., matches the inspected computer code). This may involve comparing a portion of the attestation response and validation data to see if they match (e.g., hash of executable code in TEE matches hash of computer code from repository). If they match, that may indicate the executable code in the TEE is the same as the computer code from the independent source and has not been improperly modified, compromised, or subverted.

The attestation result 257 may include a notification indicating whether the part of the host is verified. The attestation server 190 may provide its protected content to the computing device 110 in a security enhanced manner to enable the execution of the one or more operations. Upon receiving the attestation result 257, the attestation module 216 may enable computing device 110 to cause executable code to execute in the guest application 220. The guest application 220 may be a part of the operating system or interact with the operating system to initiate the execution of executable code as a computing process. The protected content may include one or more cryptographic bit sequences or other cryptographic keying material for storing, generating, or deriving a set of one or more cryptographic keys. The protected content may be represented in a human readable form (e.g., passcode, password), a non-human readable form (e.g., digital token, digital signature, or digital certificate), other form, or a combination thereof. The protected content may be input for a cryptographic function, output of a cryptographic function, or a combination thereof. The protected content may include one or more encryption keys, decryption keys, session keys, transport keys, migration keys, authentication keys, authorization keys, integrity keys, verification keys, digital tokens, license keys, certificates, signatures, hashes, other data or data structure, or a combination thereof. The protected content may include any number of cryptographic keys and may be used as part of a cryptographic system that provides privacy, integrity, authentication, authorization, non-repudiation, other features, or a combination thereof. Executable code may be loaded into the confidential virtual machine 142 and may control how computing device 110 interacts with the protected content. The executable code may include executable data, configuration data, other data, or a combination thereof and may be stored and executed in the confidential virtual machine 142. Executable code may be stored in any format and may include one or more file system objects (e.g., files, directories, links), database objects (e.g., records, tables, field value pairs, tuples), other storage objects, or a combination thereof.

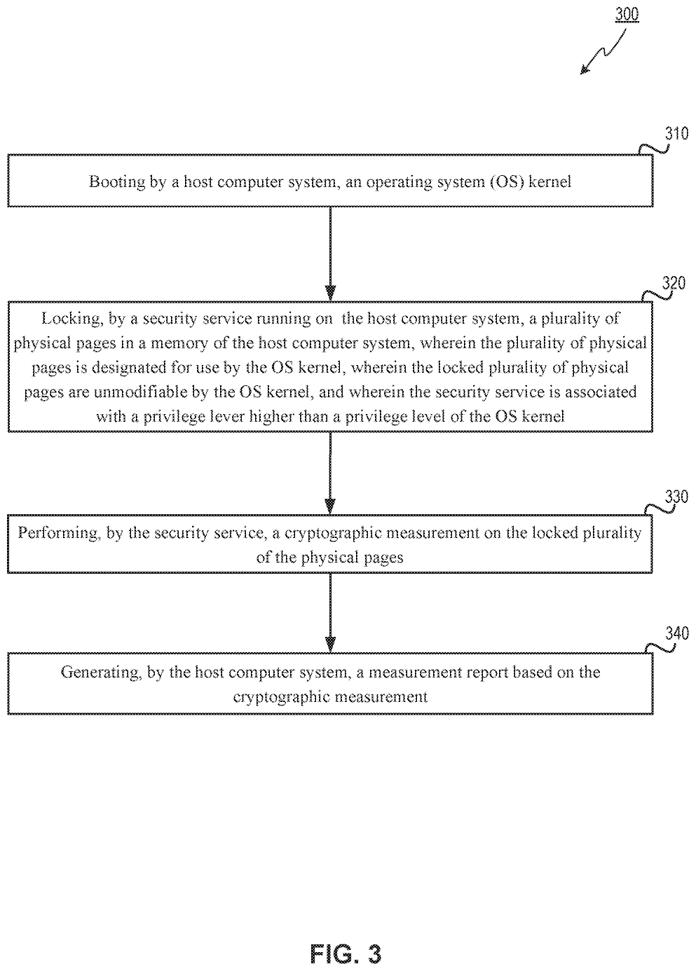

FIG. 3 depicts a flow diagram for an illustrative example of method 300 for implementing a mechanism for confidential computing to allow a host software stack to prove its identify and build trust to a virtual machine. Method 300 may be performed by computing devices that comprise hardware (e.g., circuitry, dedicated logic, programmable logic, microcode, etc.), executable code (such as is run on a general purpose computer system or a dedicated machine), or a combination of both. Method 300 and each of its individual functions, routines, subroutines, or operations may be performed by one or more processors of the computing device executing the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by computing device 110 as shown in FIGS. 1 and 2.

At operation 310, the processing logic may boot, by a host computer system, an operating system (OS) kernel. In some implementations, the processing logic may receive, by the host computer system, from a virtual machine, a host verification request. In some implementations, the processing logic may send, by the host computer system, to the virtual machine, the signed report of the cryptographic measurement in response to the host verification request. In some implementations, the processing logic may add, by a confidential computing firmware, to the plurality of physical pages, a second plurality of physical pages associated with a set of runtime services.

At operation 320, the processing logic may lock, by a security service running on the host computer system, a plurality of physical pages in a memory of the host computer system, wherein the plurality of physical pages is designated for use by the OS kernel, wherein the locked plurality of physical pages are unmodifiable by the OS kernel, and wherein the security service is running at a privilege level higher than the privilege level of the OS kernel. In some implementations, the security service is implemented by an internal component (e.g., the measurement component 214) of the host computer system. In some implementations, the security service is implemented by an external device of the host computer system.

At operation 330, the processing logic may perform, by the security service running on the host computer system, a cryptographic measurement on the locked plurality of the physical pages. In some implementations, performing the cryptographic measurement on the locked plurality of the physical pages may involve applying a cryptographic hash function to data stored in the locked plurality of the physical pages and generating a hash value.

At operation 340, the processing logic may generate, by the host computer system, a measurement report based on the cryptographic measurement. In some implementations, the measurement report based on the cryptographic measurement is used for attestation of the OS kernel.

In some implementations, the processing logic may send, by a virtual machine running under a hypervisor managed by the OS kernel, an attestation request to an attestation server. In some implementations, the security service may generate the measurement report by including the cryptographic hash value and a public key provided by the virtual machine, and sign the measurement report with a private key that is paired with the public key. In some implementations, responsive to receiving, by the virtual machine, an attestation challenge from the attestation server, the processing logic may send, by the virtual machine, to the attestation server, an attestation response comprising the measurement report cryptographically signed by a value derived from the attestation challenge. In some implementations, the security service may generate the measurement report responsive to receiving the attestation challenge. In some implementations, the attestation challenge includes a value and the virtual machine (or the security service) may use the value to cryptographically sign the measurement report. In some implementations, responsive to performing, by the attestation server, an attestation operation using the attestation response, the processing logic may receive, by the virtual machine, from the attestation server, cryptographic key data. In some implementations, the processing logic may execute, by the virtual machine, a cryptographic function that uses the cryptographic key data to access protected contents.

In some implementations, the attestation response further comprises a second measurement report signed by a second value derived from the attestation challenge, wherein the second measurement is based on a second cryptographic measurement on a locked second plurality of physical pages, wherein the second plurality of physical pages are allocated to the virtual machine.

In some implementations, the plurality of physical pages are shared by a plurality of virtual machines running under a hypervisor managed by the OS kernel, wherein each virtual machine of the plurality of virtual machines is capable to send, to the attestation server, an attestation report comprising the signed report. In some implementations, the processing logic may prevent modification of the locked plurality of physical pages by the OS kernel until rebooting the OS kernel. In some implementations, the cryptographic measurement on the locked plurality of the physical pages is performed only responsive to locking the plurality of physical pages in a memory of the host computer system.

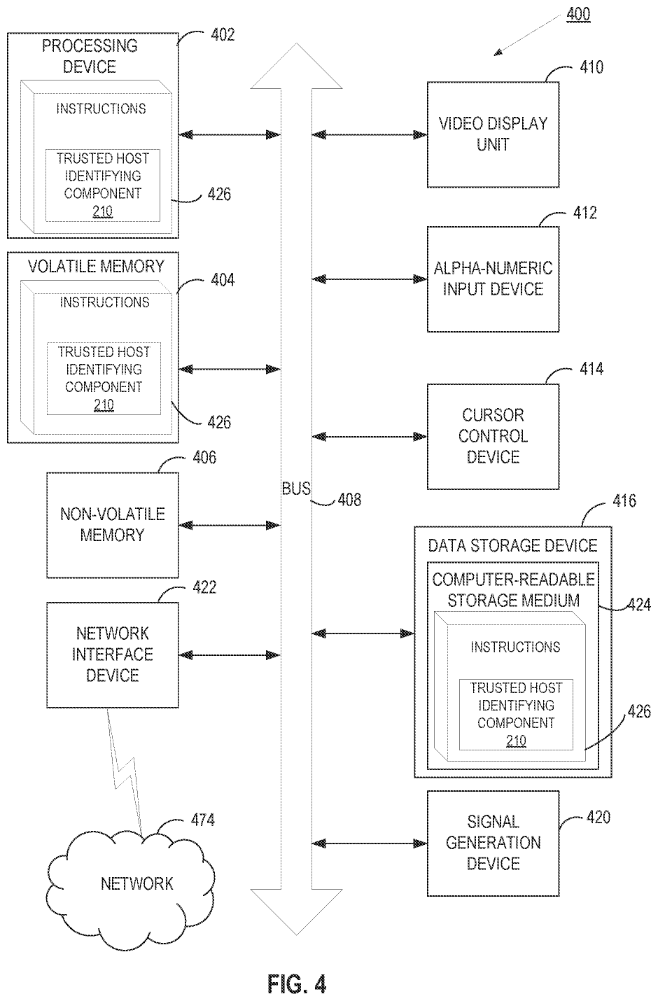

FIG. 4 depicts a block diagram of a computer system operating in accordance with one or more aspects of the present disclosure. In various illustrative examples, computer system 400 may correspond to a computing device 110. Computer system 400 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical environment, but requests for a hard disk or memory may be managed by a virtualization layer of a computing device to translate these requests to the underlying physical computing hardware resources. This type of virtualization results in multiple VMs sharing physical resources.

In certain implementations, computer system 400 may be connected (e.g., via a network, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 may include a processing device 402, a volatile memory 404 (e.g., random access memory (RAM)), a non-volatile memory 406 (e.g., read-only memory (ROM) or electrically-erasable programmable ROM (EEPROM)), and a data storage device 416, which may communicate with each other via a bus 408.

Processing device 402 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 may further include a network interface device 422. Computer system 400 also may include a video display unit 410 (e.g., an LCD), an alphanumeric input device 412 (e.g., a keyboard), a cursor control device 414 (e.g., a mouse), and a signal generation device 420.

Data storage device 416 may include a non-transitory computer-readable storage medium 424 on which may store instructions 426 encoding any one or more of the methods or functions described herein, including instructions for implementing method 300, and for encoding components of FIG. 1.

Instructions 426 may also reside, completely or partially, within volatile memory 404 and/or within processing device 402 during execution thereof by computer system 400, hence, volatile memory 404 and processing device 402 may also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “determining,” “deriving,” “encrypting,” “creating,” “generating,” “using,” “accessing,” “executing,” “obtaining,” “storing,” “transmitting,” “providing,” “establishing,” “loading,” “causing,” “performing,” “executing,” “configuring,” “receiving,” “identifying,” “initiating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements (e.g., cardinal meaning) and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 700, 800, 900, or 1000 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
booting, by a host computer system, an operating system (OS) kernel;
locking, by a security service running on the host computer system, a plurality of physical pages in a memory of the host computer system, wherein the plurality of physical pages is designated for use by the OS kernel, wherein the plurality of physical pages, upon locking, are unmodifiable by the OS kernel, and wherein the security service is associated with a privilege level higher than a privilege level of the OS kernel;
performing, by the security service, a cryptographic measurement on the plurality of the physical pages; and
generating, by the host computer system, a measurement report based on the cryptographic measurement.

2. The method of claim 1, further comprising:
sending, by a virtual machine running under a hypervisor managed by the OS kernel, an attestation request to an attestation server; and
responsive to receiving, by the virtual machine, an attestation challenge from the attestation server, generating, by the virtual machine, an attestation response comprising the measurement report cryptographically signed by a value derived from the attestation challenge.

3. The method of claim 2, further comprising:
sending, by the virtual machine, to the attestation server, the attestation response.

4. The method of claim 3, further comprising:
receiving, by the virtual machine, from the attestation server, cryptographic key data; and
executing, by the virtual machine, a cryptographic function that uses the cryptographic key data to access protected content.

5. The method of claim 2, wherein the attestation response further comprises a second measurement report signed by a second value derived from the attestation challenge, wherein the second measurement is based on a second cryptographic measurement on a second plurality of physical pages, wherein the second plurality of physical pages are allocated to the virtual machine and are locked.

6. The method of claim 1, further comprising:
adding, by the host computer system, to the plurality of physical pages, a second plurality of physical pages associated with a set of runtime services, wherein the set of runtime services includes a hypervisor to run virtual machines.

7. The method of claim 1, wherein the plurality of physical pages are shared by a plurality of virtual machines running under a hypervisor managed by the OS kernel.

8. A system comprising:
a memory; and
a processor communicably coupled to the memory, the processor to perform operations comprising:
booting, by a host computer system, an operating system (OS) kernel;
locking, by a security service running on the host computer system, a plurality of physical pages in a memory of the host computer system, wherein the plurality of physical pages is designated for use by the OS kernel, wherein the plurality of physical pages, upon locking, are unmodifiable by the OS kernel, and wherein the security service is associated with a privilege level higher than a privilege level of the OS kernel;
performing, by the security service, a cryptographic measurement on the plurality of the physical pages; and
generating, by the host computer system, a measurement report based on the cryptographic measurement.

9. The system of claim 8, wherein the operations further comprise:
sending, by a virtual machine running under a hypervisor managed by the OS kernel, an attestation request to an attestation server; and
responsive to receiving, by the virtual machine, an attestation challenge from the attestation server, generating, by the virtual machine, an attestation response comprising the measurement report cryptographically signed by a value derived from the attestation challenge.

10. The system of claim 9, wherein the operations further comprise:
sending, by the virtual machine, to the attestation server, the attestation response.

11. The system of claim 10, wherein the operations further comprise:
receiving, by the virtual machine, from the attestation server, cryptographic key data; and
executing, by the virtual machine, a cryptographic function that uses the cryptographic key data to access protected content.

12. The system of claim 9, wherein the attestation response further comprises a second measurement report signed by a second value derived from the attestation challenge, wherein the second measurement is based on a second cryptographic measurement on a second plurality of physical pages, wherein the second plurality of physical pages are allocated to the virtual machine and are locked.

13. The system of claim 8, wherein the operations further comprise:
adding, by the host computer system, to the plurality of physical pages, a second plurality of physical pages associated with a set of runtime services, wherein the set of runtime services includes a hypervisor to run virtual machines.

14. The system of claim 8, wherein the plurality of physical pages are shared by a plurality of virtual machines running under a hypervisor managed by the OS kernel.

15. A non-transitory machine-readable storage medium storing instructions which, when executed, cause a processor to perform operations comprising:
booting, by a host computer system, an operating system (OS) kernel;
locking, by a security service running on the host computer system, a plurality of physical pages in a memory of the host computer system, wherein the plurality of physical pages is designated for use by the OS kernel, wherein the plurality of physical pages, upon locking, are unmodifiable by the OS kernel, and wherein the security service is associated with a privilege level higher than a privilege level of the OS kernel;
performing, by the security service, a cryptographic measurement on the locked plurality of the physical pages; and
generating, by the host computer system, a measurement report based on the cryptographic measurement.

16. The non-transitory machine-readable storage medium of claim 15, wherein the operations further comprise:
sending, by a virtual machine running under a hypervisor managed by the OS kernel, an attestation request to an attestation server; and
responsive to receiving, by the virtual machine, an attestation challenge from the attestation server, generating, by the virtual machine, an attestation response comprising the measurement report cryptographically signed by a value derived from the attestation challenge.

17. The non-transitory machine-readable storage medium of claim 16, wherein the operations further comprise:
receiving, by the virtual machine, from the attestation server, cryptographic key data; and
executing, by the virtual machine, a cryptographic function that uses the cryptographic key data to access protected content.

18. The non-transitory machine-readable storage medium of claim 16, wherein the attestation response further comprises a second measurement report signed by a second value derived from the attestation challenge, wherein the second measurement is based on a second cryptographic measurement on a second plurality of physical pages, wherein the second plurality of physical pages are allocated to the virtual machine and are locked.

19. The non-transitory machine-readable storage medium of claim 15, wherein the operations further comprise:
adding, by the host computer system, to the plurality of physical pages, a second plurality of physical pages associated with a set of runtime services, wherein the set of runtime services includes a hypervisor to run virtual machines.

20. The non-transitory machine-readable storage medium of claim 15, wherein the plurality of physical pages are shared by a plurality of virtual machines running under a hypervisor managed by the OS kernel.
